(19) United States
(12) Patent Application Publication
(10) Pub. No.: US 2026/0239502 A1
(43) Pub. Date: Aug. 13, 2026

(54) A LED FILAMENT ARRANGEMENT

(71) Applicant: SIGNIFY HOLDING B.V., EINDHOVEN (NL)

(72) Inventors: TIES VAN BOMMEL, HORST (NL); ROBERT JACOB PET, WAALRE (NL)

(21) Appl. No.: 19/156,544

(22) PCT Filed: Feb. 12, 2024
(86) PCT No.: PCT/EP2024/053403

§ 371 Date: Aug. 14, 2025

(30) Foreign Application Priority Data
Feb. 16, 2023 (EP) 23156965.8

(51) Int. Cl. H05B 45/20; F21K 9/232; H05B 45/3577

(52) U.S. Cl. CPC H05B 45/20; F21K 9/232; H05B 45/3577

(57) ABSTRACT

A light emitting diode, LED, filament arrangement (1) comprising at least one first filament (3) configured to, in operation, emit first light having a first correlated color temperature, CCT1, at least one second filament (4) configured to, in operation, emit second light having a second correlated color temperature, CCT2, where CCT2>CCT1, and at least one third filament (5) configured to, in operation, emit third light having a third color temperature, CCT3, where CCT3>CCT2, where each of the at least one first, second and third filament (3; 4; 5) comprises a carrier (31; 41; 51) of elongated shape, where a plurality of light emitting diodes (32; 42; 52) is arranged on the carrier (31; 41; 51), and a control unit (6) configured to control a first luminous flux, L1, of the first light, a second luminous flux, L2, of the second light and a third luminous flux, L3, of the third light according to at least one predetermined setting in order to control the total correlated color temperature, CCTtot, of the LED filament arrangement light as a function of the at least one predetermined setting, where the control unit (6) is configured to control a switching of the at least one second filament (4) as a function of the luminous flux, L1, of the first light, and a switching of the at least one third filament (5) as a function of the luminous flux, L2, of the second light.

### FIELD OF THE INVENTION

The invention relates to a light emitting diode, LED, filament arrangement configured to, in operation, emit LED filament arrangement light, comprising at least one first filament configured to, in operation, emit first light having a first correlated color temperature, CCT1, at least one second filament, configured to, in operation, emit second light having a second correlated color temperature, CCT2, and at least one third filament, configured to, in operation, emit third light having a third color temperature, CT3, and a control unit.

The term “control unit” as used herein is intended to mean a device, arrangement, element, or the like, which is configured to control first, second and third intensities of the light emitted from the first, the second and the third filament(s), respectively. The control of the control unit is performed according to one or more predetermined settings. The term “predetermined setting”, as used herein is intended to mean a setting, setup, program, relationship, or the like, which is set or determined in advance. The control unit may hereby control the total color temperature of the light emitted from the LED filament arrangement as a function of this or these predetermined setting(s).

### BACKGROUND OF THE INVENTION

A trend in lighting is LED filament lamps. An LED filament lamp is an LED lamp which comprises a LED filament, and which is designed to resemble a traditional incandescent light bulb with a visible filament for aesthetic and light distribution purposes, but with the high efficiency of light-emitting diodes.

A LED filament is providing LED filament light and comprises a plurality of light emitting diodes (LEDs) arranged in a linear array. Preferably, the LED filament has a length L and a width W, wherein L>5 W. The LED filament may be arranged in a straight configuration or in a non-straight configuration such as for example a curved configuration, a 2D/3D spiral or a helix. Preferably, the LEDs are arranged on an elongated carrier like for instance a carrier, that may be rigid (made from, e.g., a polymer, glass, quartz, metal or sapphire) or flexible (e.g., made of a polymer or metal, e.g., a film or foil).

In case the carrier comprises a first major surface and an opposite second major surface, the LEDs are arranged on at least one of these surfaces. The carrier may be reflective or light transmissive, such as translucent and preferably transparent.

As used herein, the terms carrier and elongated carrier may be used interchangeably, such that the elongated carrier may also simply be denoted carrier.

The LED filament may comprise an encapsulant at least partly covering at least part of the plurality of LEDs. The encapsulant may also at least partly cover at least one of the first major surface and second major surface. The encapsulant may be a polymer material which may be flexible such as for example a silicone. Further, the LEDs may be arranged for emitting LED light, e.g., of different colors or spectrums. The encapsulant may comprise a luminescent material that is configured to at least partly convert LED light into converted light. The luminescent material may be a phosphor such as an inorganic phosphor and/or quantum dots or rods. The phosphor may comprise a first phosphor providing green/yellow light and/or a second phosphor providing red light. The first phosphor may comprise YAG and/or LuAG. The second phosphor may comprise a KSiF phosphor.

The LED filament may comprise multiple sub-filaments.

US 2021/0018146 A1 discloses a LED filament lamp with a spiral multiple, particularly such as two or three, LED filaments, the Correlated Color Temperature (CCT) of the three filaments being different from each other. If two filaments are provided, the color of the two filaments may be red and yellow and thus the filament can give red, yellow and a mixture of red and yellow filament light. If three filaments are provided, the color of two of the three filaments can be white with different CCTs, and the third filament can be a yellow filament. They can also be also red, green, and blue filaments or a combination of red, green, blue, and white filaments. Thus, using the filaments of three CCTs in different combinations a combination of seven CCTs can be obtained from the lamp. The lamp may also include not only red, green, blue filaments but also filaments being two different CCTs of white.

It is desired to improve the performance and/or appearance of a LED filament arrangement. It is further desired to provide a LED filament arrangement with real black body locus, BBL, dimming and a pleasant appearance as perceived by a viewer.

US 2019/017657 discloses a LED filament type light source that includes a plurality of LED modules, a coupler, and a common connection portion. The LED modules are in a polygonal prism structure and emit white light having different color temperatures or light of different wavelengths. Each LED module having a bar shape at a respective side surface of the polygonal prism structure and includes a first connection electrode and a second connection electrode. The coupler couples the LED modules to maintain the polygonal prism structure. The common connection portion is at one end of the polygonal prism structure and is commonly connected to the second connection electrode of each of the LED modules.

U.S. Pat. No. 8,740,663 discloses a light emitting device package assembly includes a light emitting device package body, and first, second and third white light emitting devices on the package body, each of the first, second and third white light emitting devices emits light when energized having a chromaticity that falls within a respective one of first, second and third non-overlapping chromaticity regions in a two-dimensional chromaticity space. The first, second and third chromaticity regions are spaced apart in the two-dimensional chromaticity space by respective regions having at least the size of a seven step MacAdam ellipse. Related solid state luminaires and methods are also disclosed.

### SUMMARY OF THE INVENTION

It is an object of the present invention to overcome this problem, and to provide a LED filament arrangement with one or more of an improved performance and an improved appearance.

It is a further object of the invention to provide a LED filament arrangement with real black body locus, BBL, dimming and a pleasant appearance as perceived by a viewer.

According to a first aspect of the invention, this and other objects are achieved by means of a light emitting diode, LED, filament arrangement configured to, in operation, emit LED filament arrangement light, the LED filament arrangement comprising at least one first filament configured to, in operation, emit first light having a first correlated color temperature, CCT1, at least one second filament, configured to, in operation, emit second light having a second correlated color temperature, CCT2, where CCT2>CCT1, and at least one third filament, configured to, in operation, emit third light having a third color temperature, CCT3, where CCT3>CCT2. Each of the at least one first filament, the at least one second filament and the at least one third filament comprises a carrier of elongated shape, where a plurality of light emitting diodes is arranged on the carrier. The LED filament arrangement further comprises a control unit configured to control a first luminous flux, L1, of the first light emitted from the at least one first filament, to control a second luminous flux, L2, of the second light emitted from the at least one second filament and to control a third luminous flux, L3, of the third light emitted from the at least one third filament according to at least one predetermined setting in order to control the total correlated color temperature, CCTtot, of the LED filament arrangement light as a function of the at least one predetermined setting. The control unit is configured to control a switching of the at least one second filament as a function of the luminous flux, L1, of the first light emitted from the at least one first filament. The control unit is configured to control a switching of the at least one third filament as a function of the luminous flux, L2, of the second light emitted from the at least one second filament, and 450 K≥(CCT2−CCT1)≥150 K, (CCT3−CCT2)≥1000 K, CCT3≥3000K, and 1500 K≤CCT1≤2500 K.

Thereby, and especially by providing the LED filament arrangement with a control unit configured to control the respective LEDs of the first, second and third filament as described above, and further by providing the respective pluralities of LEDs of the first, second and third filament to fulfill the tree above mentioned relations between the respective CCT of the light emitted by the respective pluralities of LEDs, a LED filament arrangement having at least one of an improved performance and an improved appearance is provided.

Furthermore, such a LED filament arrangement is provided with real black body locus, BBL, dimming and a pleasant appearance as perceived by a viewer.

In an embodiment, the first predetermined threshold is lower than the second predetermined threshold, for instance by at least 100 lm or by at least 200 lm, and the second predetermined threshold is lower than the third predetermined threshold, for instance by at least 100 lm or by at least 200 lm.

In an embodiment, the first predetermined threshold may be in a range from 80 lm to 300 lm, or in a range from 100 lm to 200 lm, such as for example 120 lm.

In an embodiment, the second predetermined threshold may be in a range from 250 lm to 700 lm, or in a range from 300 lm to 500 lm, such as for example 450 lm.

In an embodiment, the third predetermined threshold may be at least 500 lm, or at least 700 lm, such as for example 750 lm.

In an embodiment, the first predetermined threshold may be in a range from 10% to 30%, or in a range from 15% to 25%, of a maximum luminous flux of the LED filament arrangement light.

In an embodiment, the second predetermined threshold may be in a range from 25% to 60%, or in a range from 30% to 55%, of a maximum luminous flux of the LED filament arrangement light.

In an embodiment, the third predetermined threshold may be in a range from 55% to 100%, or in a range from 60% to 100% of a maximum luminous flux of the LED filament arrangement light.

In an embodiment, (CCT2−CCT1)≥150 K, (CCT3−CCT2)≥1500 K, and 12*(CCT2−CCT1)≥(CCT3−CCT2)≥2*(CCT2−CCT1).

In an embodiment, the control unit is configured to increase the first luminous flux, L1, to a first predetermined threshold, and, subsequently, at the first predetermined threshold, switching on the at least one second filament and increasing the second luminous flux, L2, to a second predetermined threshold, and, subsequently, at the second predetermined threshold, switching on the at least one third LED filament (5) and increasing the third luminous flux, L3.

In an embodiment, the control unit is configured to increase the first luminous flux, L1, and the second luminous flux, L2, simultaneously, where the increase in luminous flux of the second LED filament light is higher than the increase in luminous flux of the first LED filament light; and wherein the control unit is configured to increase the second luminous flux, L2, to a second predetermined threshold, and, subsequently, at the second predetermined threshold, switching on the at least one third LED filament and increasing the third luminous flux, L3.

Thereby, the third LED filament is switched on while the first and second filaments are already on. Thereby, a LED filament arrangement having an improved performance and a particularly simple to execute luminous flux control of the first luminous flux L1, the second luminous flux L2 and the third luminous flux L3, respectively, is provided for. Especially, such a LED filament arrangement ensures control of the first luminous flux L1, the second luminous flux, L2 and the third luminous flux L3, respectively, in such a manner that the individual filaments remain invisible to the viewer during control.

In an embodiment, one of the following applies: (i) the third luminous flux of the third LED filament light is increased to a third predetermined threshold, and, subsequently at said third predetermined threshold, decreasing the first luminous flux, L1, of the first LED filament light or switching off the at least one first LED filament (3), and (ii) upon increasing the third luminous flux, L3, simultaneously decreasing the first luminous flux, L1, of the first LED filament light or switching off the at least one first LED filament (3) at said second predetermined threshold.

Such a LED filament arrangement ensures control of the first luminous flux L1, the second luminous flux L2 and the third luminous flux L3, respectively, in such a manner that the individual filaments remain invisible to the viewer during control.

In an embodiment, a decrease or switching off of the first LED filament is compensated by a higher increase of luminous flux of the second and/or third LED filament, such that for example the total luminous flux is continuously increased (over time).

In an embodiment, 400 K>(CCT2−CCT1)>150 K.

Thereby, a LED filament arrangement having a further improved appearance is provided for.

In an embodiment, CCTtot=3000 K at 50-80% of a maximum luminous flux, Lmax, of the LED filament arrangement light.

Thereby, a LED filament arrangement having a particularly improved appearance is provided for, while also ensuring a particularly well-functioning BBL dimming.

In an embodiment, the maximum luminous flux, Lmax, of the LED filament arrangement light is 750 lm 150 lm.

In an embodiment, a maximum luminous flux, Lmax, of the LED filament arrangement light is at least 700 lm or 1150 lm 350 lm or at least 1100 lm or at least 1300 lm.

Thereby, a LED filament arrangement having an improved appearance and especially a particularly pleasant appearance as perceived by a viewer is provided for. Furthermore, user experiments have shown that at very high CCTs a very high luminous flux is desired. This is not needed for lower CCTs. By especially providing that the maximum luminous flux, Lmax, of the LED filament arrangement light is at least 1100 lm or at least 1300 lm, a LED filament arrangement is provided which is able to provide very high CCTs.

In an embodiment, a maximum total correlated color temperature, CCTmax, of the LED filament arrangement light is at least 3500 K or at least 4000 K.

In an embodiment, a minimum total correlated color temperature, CCTmin, of the LED filament arrangement light is at most 2300K.

Keeping the CCT of the LED filament arrangement within such upper and lower limits, respectively, provides for a LED filament arrangement which at all times has a particularly pleasant appearance as perceived by a viewer. Furthermore, user experiments show that extreme low CCTs are desired, and such a LED filament arrangement is able to provide such extreme low CCTs.

In an embodiment, CCT3≤6500K.

In an embodiment, the LED filament arrangement further comprises M first LED filaments, N second LED filaments and O third LED filaments, wherein 10≥M+N+O≥4 and N≥M and O≥N.

Thereby, a LED filament arrangement is provided with which the above-mentioned advantages are obtained, and further with which the total luminous flux of the resulting LED filament arrangement light may be increased.

In an embodiment, the number of first, second and third LED filaments further fulfill the relations O>N and O>M.

Such a LED filament arrangement is provided with a higher number of filaments providing light with the highest color temperature. Thereby, the CCT of the resulting LED filament arrangement may be increased.

In an embodiment, increase in CCTtot is non-linear with respect to the luminous flux of the LED filament arrangement light.

Thereby, a LED filament arrangement having a particularly pleasant appearance is provided for, while also ensuring a particularly good BBL dimming.

In an embodiment, the higher the luminous flux of the LED filament arrangement light, the steeper the increase in CCTtot.

Thereby, a LED filament arrangement having a particularly pleasant appearance is provided for, while also ensuring a particularly good BBL dimming.

In an embodiment, the LED filament arrangement further comprises one or more of a transparent encapsulant, a transparent envelope and a base for electrically and mechanically connecting said lamp to a socket or a socket of a luminaire.

The invention further relates to a LED filament lamp comprising a LED filament arrangement according to the invention.

The LED filament lamp may further comprise a light transmissive envelope and a base for electrically and mechanically connecting the LED filament lamp to a socket or a socket of a luminaire.

The invention further relates to a luminaire comprising a Led filament lamp according to the invention or comprising a LED filament arrangement according to the invention.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a top view of a first embodiment of a light emitting device, LED, filament arrangement according to the invention and comprising a first, a second and a third filament.

FIG. 2 shows a cross-sectional side view of the LED filament arrangement according to FIG. 1.

FIG. 3 shows a top view of a second embodiment of a LED filament arrangement according to the invention and comprising two first, two second and two third filaments.

FIG. 4 shows a table listing varying data including the correlated color temperature, CCT, and luminous flux of each of the first, second and third filament as well as the luminous flux of the LED filament arrangement as a whole, the data being obtained as result of a simulation performed on a LED filament arrangement according to FIG. 3.

FIG. 5 shows a graph illustrating the spectrum locus, the purple boundary and the black body locus, BBL, of a LED filament arrangement according to FIG. 3 as result of a simulation performed on such a LED filament arrangement.

FIG. 6 shows a graph illustrating the CCT as a function of the luminous flux of the LED filament light lamp of a LED filament arrangement according to FIG. 3 as result of a simulation performed on such a LED filament arrangement.

FIG. 7 shows a light bulb comprising a LED filament arrangement according to the invention.

FIGS. 8, 9 and 10 show graphs illustrating schematic examples of luminous flux variations as function of time as result of a simulation performed on a LED filament arrangement according to the invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

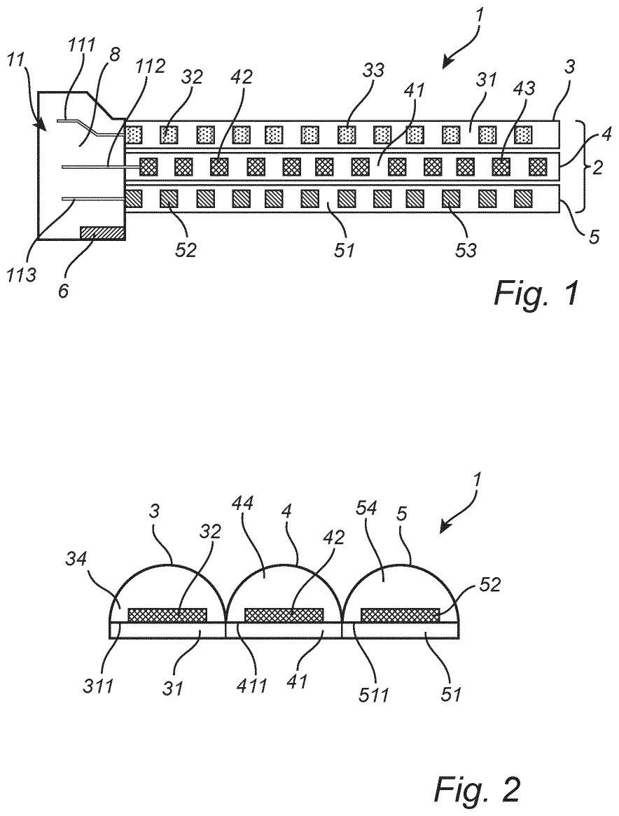

FIG. 1 shows a top view of a first embodiment of a light emitting device, LED, filament arrangement 1 according to the invention and configured to, in operation, emit LED filament arrangement light. FIG. 2 shows a cross sectional side view of the LED filament arrangement 1.

Generally, and irrespective of the embodiment, the LED filament arrangement 1 comprises at least one LED light source 2 and a control unit 6.

The LED light source 2 comprises a first filament 3 configured to, in operation, emit first light having a first correlated color temperature, CCT1. The LED light source 2 comprises at least one second filament 4, configured to, in operation, emit second light having a second correlated color temperature, CCT2. The LED light source 2 comprises at least one third filament 5 configured to, in operation, emit third light having a third color temperature, CCT3. The LED filament arrangement light is to be understood as being the combination of the first light, the second light and the third light.

Put in other terms, irrespective of the embodiment, the LED filament arrangement 1 comprises a control unit 6, a first filament 3 configured to, in operation, emit first light having a first correlated color temperature, CCT1, at least one second filament 4, configured to, in operation, emit second light having a second correlated color temperature, CCT2, and at least one third filament 5 configured to, in operation, emit third light having a third color temperature, CCT3.

The first filament 3 comprises a first carrier 31 of elongated shape, and a first plurality of LEDs 32, 33 arranged on the first carrier 31. The second filament 4 comprises a second carrier 41 of elongated shape, and a second plurality of LEDs 42, 43 arranged on the second carrier 41. The third filament 5 comprises a third carrier 51 of elongated shape, and a third plurality of LEDs 52, 53 arranged on the third carrier 51.

The control unit 6 is configured to control a first luminous flux, L1, of the first light emitted from the first filament 3. The control unit 6 is configured to control a second luminous flux, L2, of the second light emitted from the second filament 4. The control unit 6 is configured to control a third luminous flux, L3, of the third light emitted from the third filament 5. The control unit 6 is configured to control the first, second and third intensities, L1, L2 and L3, according to at least one predetermined setting in order to control the total correlated color temperature, CCTtot, of the LED filament arrangement light as a function of the at least one predetermined setting. The control unit 6 is further configured to control a switching of the second filament 4 as a function of the luminous flux, L1, of the first light emitted from the first filament 3. The control unit 6 is configured to control a switching of the third filament 5 as a function of the luminous flux, L2, of the second light emitted from the second filament 4.

The first correlated color temperature, CCT1, the second correlated color temperature, CCT2, and the third correlated color temperature, CCT3, are chosen such that the following conditions apply:

$$CCT 2 > CCT 1 ,$$

$$CCT 3 > CCT 2 ,$$

$$450 K \geq ( CCT 2 - CCT 1 ) \geq 150 K ,$$

$$( CCT 3 - CCT 2 ) \geq 1000 K ,$$

$$CCT 3 \geq 3000 K , and$$

$$1500 K \leq CCT 1 \leq 2500 K .$$

Additionally, or alternatively, the first correlated color temperature, CCT1, the second correlated color temperature, CCT2, and the third correlated color temperature, CCT3, may be chosen such that the following conditions apply:

$$( CCT 2 - CCT 1 ) > 150 K ,$$

$$( CCT 3 - CCT 2 ) > 1500 K , and$$

$$12 * ( CCT 2 - CCT 1 ) \geq ( CCT 3 - CCT 2 ) \geq 2 * ( CCT 2 - CCT 1 ) .$$

In other words, the first plurality of LEDs 32, 33 arranged on the first carrier 31, the second plurality of LEDs 42, 43 arranged on the second carrier 41 and the third plurality of LEDs 52, 53 arranged on the third carrier 51, respectively, are chosen such that the first light emitted by the first filament 3, the second light emitted by the second filament 4 and the third light emitted by the third filament 5, respectively, fulfill the above conditions for the respective CCT.

The first correlated color temperature, CCT1, the second correlated color temperature, CCT2, and the third correlated color temperature, CCT3, may further be chosen such that the following additional condition also applies:

$$400 K > ( CCT 2 - CCT 1 ) > 150 K .$$

The LED filament arrangement 1 may further comprise a base 8 for electrically and mechanically connecting the LED filament arrangement 1 to a socket or a socket of a luminaire or another suitable type of connection to a power supply. Electrical circuitry 11 is coupled to the first plurality of LEDs 32, 33 such as to supply the first plurality of LEDs 32, 33 with electrical energy, to the second plurality of LEDs 42, 43 such as to supply the second plurality of LEDs 42, 43 with electrical energy and to the third plurality of LEDs 52, 53 such as to supply the third plurality of LEDs 52, 53 with electrical energy. The electrical circuitry 11 is not visible in FIG. 2 but is shown in FIG. 1. The electrical circuitry 11 may be arranged on or in the respective elongated carrier 31, 41, 51. The electrical circuitry 11 may comprise one or more electrical tracks 111, 112, 113, such as for instance one track for each of the first, second and third plurality of LEDs 32, 33; 42, 43; 52, 53 respectively.

As may be seen on FIG. 2, the LED filament arrangement 1 may further comprise a transparent encapsulant 34, 44, 54. The transparent encapsulant 34, 44, 54 may as shown be provided comprising three sections, namely a first section 34 at least partially enclosing the first plurality of LEDs 31, a second section 44 at least partially enclosing the second plurality of LEDs 41, and a third section 54 at least partially enclosing the third plurality of LEDs 51. Alternatively, the transparent encapsulant 34, 44, 45 may be provided as a one-piece encapsulant at least partially enclosing all three pluralities of LEDs 31, 41 and 51. The encapsulant 34, 44, 54 may comprise a translucent material. The translucent material of the encapsulant 34, 44, 54 may be a polymer, such as a silicone which is capable of withstanding high intensity light and heat.

As mentioned above, and still referring to FIG. 2, the first plurality of LEDs 32, the second plurality of LEDs 42, and the third plurality of LEDs 52 are arranged on a carrier 31, 41, 51, respectively. The first plurality of LEDs 32, the second plurality of LEDs 42, and the third plurality of LEDs 52 are arranged on a respective surface 311, 411, 511 of the respective carrier 31, 41, 51. The carrier 31, 41, 51 best seen in FIG. 2. The surface 311, 411, 511 is a first major surface 311, 411, 511 of the respective carrier 31, 41, 51. The carrier 31, 41, 51 is an elongated carrier 31, 41, 51. The elongated carrier 31, 41, 51 may be a substrate. The elongated carrier 31, 41, 51 or substrate may be a printed circuit board (PCB). The elongated carrier 31, 41, 51 may be provided in one piece, or may be made up of three separate elongated carriers 31, 41, 51.

The control unit 6 may further be configured to increase the first luminous flux, L1, to a first predetermined threshold, and, subsequently, switching on the at least one second filament 4 and increasing the second luminous flux, L2. The control unit 6 may further be configured to increase the second luminous flux, L2, to a second predetermined threshold, and, subsequently, switching on the at least one third filament 5 and increasing the third luminous flux, L3.

The control unit 6 may further be configured control the first luminous flux, L1, the second luminous flux, L2, and the third luminous flux, L3, to ensure that one or more of the following conditions are fulfilled:

$$CCTtot = 3000 K at 65 - 85 \% of Lmax ,$$

$$CCTmax \geq 3500 K ,$$

$$CCTmax \geq 4000 K ,$$

$$CCTmin \leq 2500 K ,$$

$$CCTmin \leq 2300 K ,$$

$$Lmax = 750 lm \pm 150 lm ,$$

$$Lmax = 1150 lm \pm 350 lm , and$$

$$Lmax \geq 700 lm ,$$

where CCTtot is the total correlated color temperature of the LED filament arrangement light, Lmax is the maximum luminous flux of the LED filament arrangement light, CCTmax is the maximum total correlated color temperature of the LED filament arrangement, and CCTmin is the minimum total correlated color temperature of the LED filament arrangement.

The control unit 6 may further be configured control the first luminous flux, L1, the second luminous flux, L2, and the third luminous flux, L3, in such a way as to ensure that the increase in CCTtot is non-linear with respect to the luminous flux of the LED filament arrangement light.

The control unit 6 may further be configured control the first luminous flux, L1, the second luminous flux, L2, and the third luminous flux, L3, in such a way as to ensure that the higher the luminous flux of the LED filament arrangement light, the steeper the increase in CCTtot.

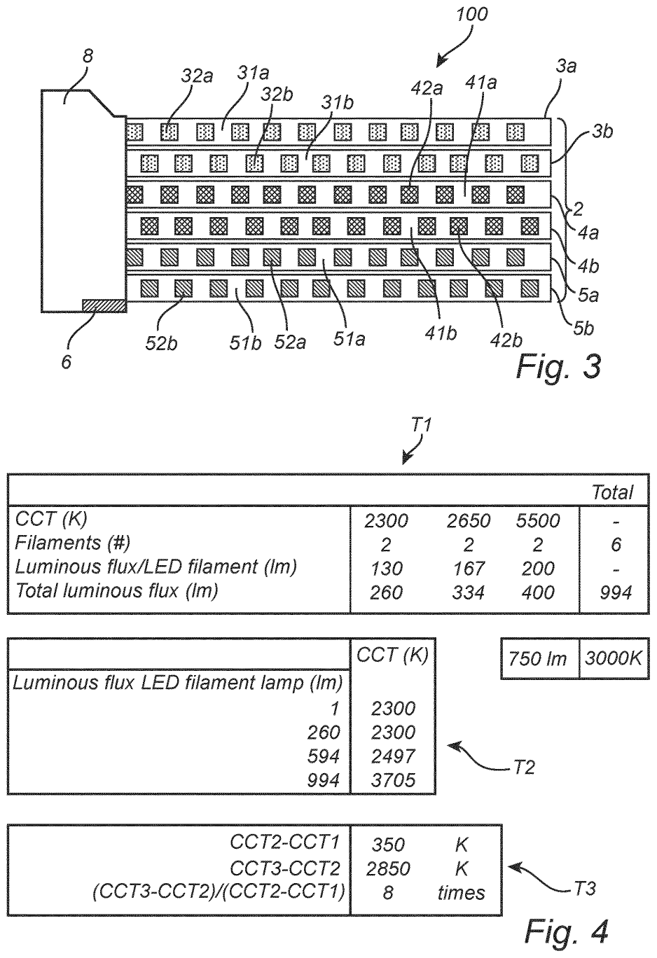

FIG. 3 shows a top view of a second embodiment of a light emitting device, LED, filament arrangement 100 according to the invention and configured to, in operation, emit LED filament arrangement light.

LED filament arrangements 100 as that shown on FIG. 3 differ from the LED filament arrangement 1 described above in relation to FIGS. 1 and 2 in virtue of the following features only.

Generally, LED filament arrangements 100 as that shown on FIG. 3 comprise M first LED filaments, N second LED filaments and O third LED filaments, where M, N and O are integers being equal to or larger than one and being chosen to fulfill the following relations:

$$10 \geq M + N + O \geq 4 ,$$

$$N \geq M , and$$

$$O \geq N .$$

Furthermore, and optionally, M, N and O may further be chosen to fulfill the following additional relations:

$$O > N , and$$

$$O > M .$$

The embodiment shown on FIG. 3, illustrates an exemplary LED filament arrangement 100 which comprises two first filaments 3a, 3b, two second filaments 4a, 4b and two third filaments 5a, 5b. The LED filament arrangement 100 thus fulfills the three first relations listed above, but not the additional two optional relations.

The two first filaments 3a, 3b each comprise a first carrier 31a, 32a and a first plurality of LEDs 32a, 32b arranged on the respective first carrier 31a, 32a. The two second filaments 4a, 4b each comprise a second carrier 41a, 42a and a second plurality of LEDs 42a, 42b arranged on the respective second carrier 41a, 42a. The two third filaments 5a, 5b each comprise a third carrier 51a, 52a and a third plurality of LEDs 52a, 52b arranged on the respective third carrier 51a, 52a.

Simulations were made on a LED filament arrangement 100 of the type shown in FIG. 3 and described above. FIGS. 4, 5 and 6 shows the results of the simulations made.

FIG. 4 shows a table with three parts, T1, T2 and T3, listing varying data related to the LED filament arrangement 100 according to FIG. 3.

The upper most part T1 of the table shows that the simulation were based on a LED filament arrangement 100 with the following. Two first filaments 3a, 3b providing first light with a CCT of 2300 K, a luminous flux per filament of 130 lm and a total luminous flux of 260 lm. Two second filaments 4a, 4b providing second light with a CCT of 2650 K, a luminous flux per filament of 167 lm and a total luminous flux of 334 lm. Two third filaments 5a, 5b providing third light with a CCT of 5500 K, a luminous flux per filament of 200 lm and a total luminous flux of 400 lm.

The middle part T2 of the table shows the CCT of the resulting LED filament arrangement light for four different values of the luminous flux of the resulting LED filament arrangement light. At a luminous flux of 1 lm, the resulting CCT is 2300 K. At a luminous flux of 260 lm, the resulting CCT is 2300 K. At a luminous flux of 594 lm, the resulting CCT is 2497 K. Finally, at a luminous flux of 994 lm, the resulting CCT is 3705 K.

The lower part T3 of the table lists the result of calculating three different relations between the CCTs of the respective first, second and third filament 3a, 3b, 4a, 4b, 5a, 5b.

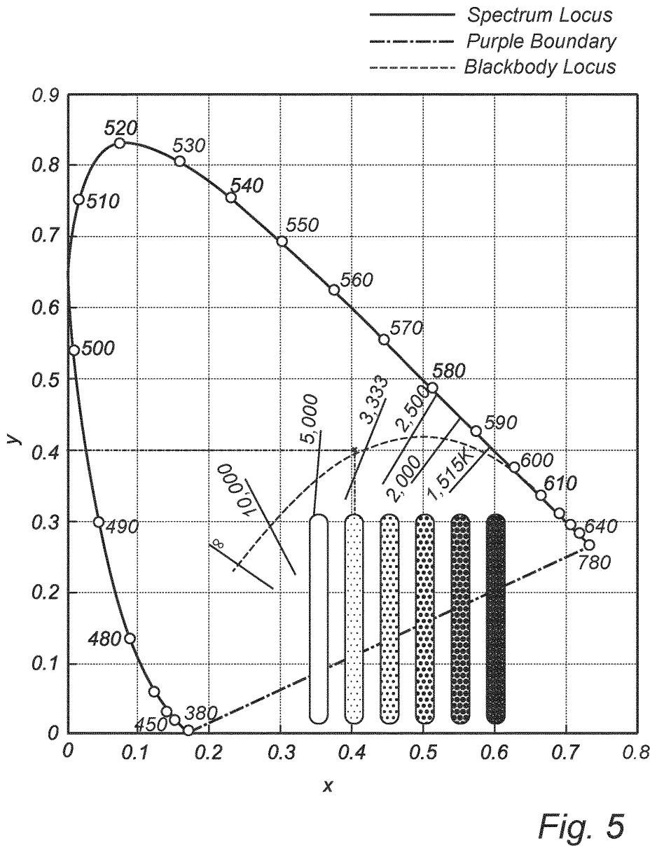

FIG. 5 shows a graph illustrating the spectrum locus, the purple boundary and the black body locus, BBL, of the LED filament arrangement 100 according to FIG. 3 as result of simulations performed on such a LED filament arrangement.

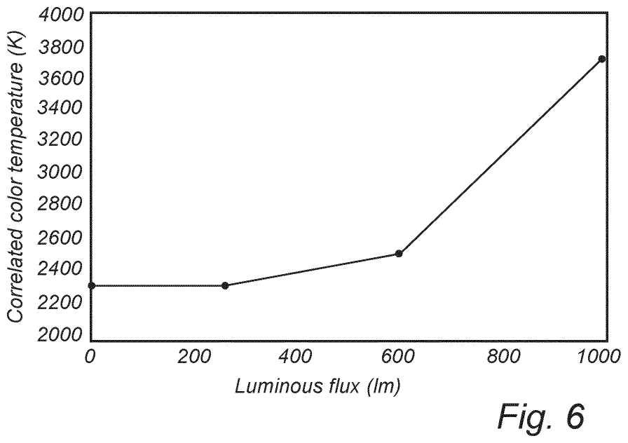

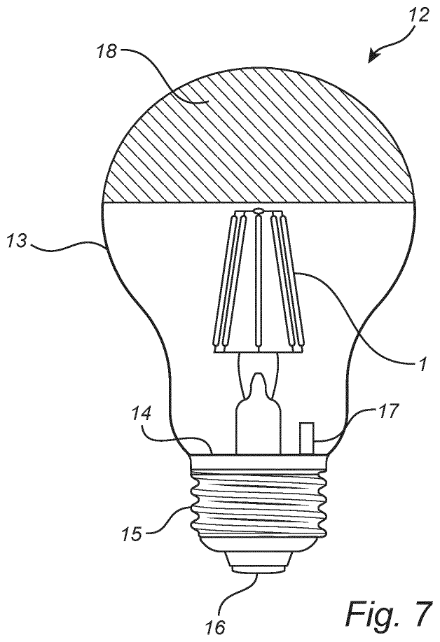

FIG. 6 shows a graph illustrating the CCT as a function of the luminous flux of a LED filament arrangement according to FIG. 3 as result of simulations performed on such a LED filament arrangement, and thus based on the numbers listed in the middle part T2 of the table shown in FIG. 4.

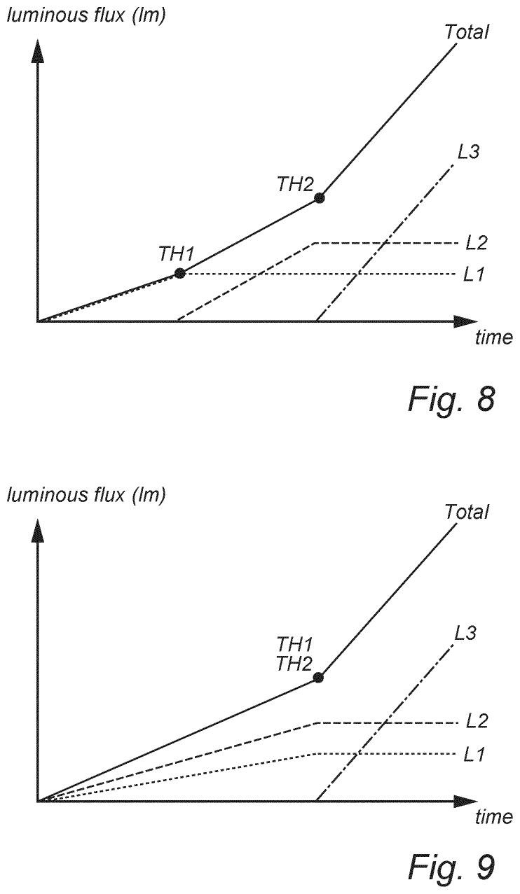

FIGS. 8, 9 and 10 show three different graphs illustrating schematic examples of luminous flux variations as function of time as result of a simulation performed on a LED filament arrangement according to the invention. All three graphs show the first luminous flux, L1, the second luminous flux, L2, and the third luminous flux, L3, separately as well as the total luminous flux being the sum of L1, L2 and L3.

FIG. 8 illustrates a situation in which the first luminous flux, L1, is increased to a first predetermined threshold, TH1, the second luminous flux, L2, is subsequently, starting at the first predetermined threshold, TH1, increased to a second predetermined threshold, TH2, and the third luminous flux, L3 is subsequently, starting at the second predetermined threshold, TH2, increased.

FIG. 9 illustrates a situation in which the first luminous flux, L1, and the second luminous flux, L2, are increased simultaneously to a first and a second threshold, TH1 and TH2, respectively, such that the increase in the second luminous flux is higher than the increase in the first luminous flux, and the third luminous flux, L3, is subsequently, starting at the first and second predetermined threshold, TH1 and TH2, increased.

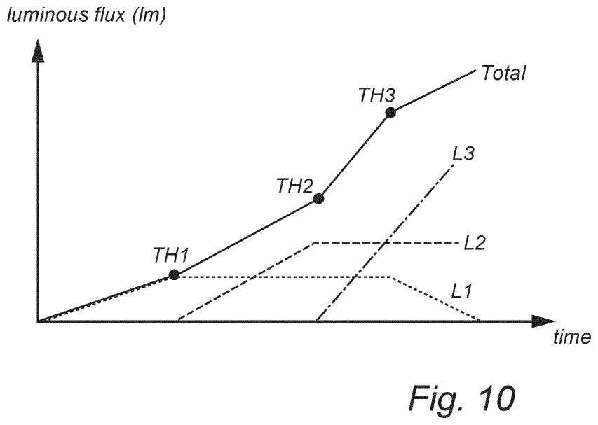

FIG. 10 illustrates a situation in which the first luminous flux, L1, is increased to a first predetermined threshold, TH1, the second luminous flux, L2, is subsequently, starting at the first predetermined threshold, TH1, increased to a second predetermined threshold, TH2, the third luminous flux, L3 is subsequently, starting at the second predetermined threshold, TH2, increased, and the first luminous flux, L1, is subsequently, starting at a third predetermined threshold, TH3, decreased.

Turning finally to FIG. 7, an exemplary LED filament lamp in the form of a light bulb 12 is shown. The light bulb 12 comprises a LED filament arrangement 1 according to any embodiment of the invention. In the embodiment shown, the LED filament arrangement 1 comprises substantially straight filaments. The filaments of such a LED filament arrangement 1 may in other embodiments be filaments with another shape, such as, but not limited to, spiral-shaped, helix-shaped, meandering, twisted, flat and combinations thereof.

The light bulb 12 further comprises a driver or controller 17 configured for controlling the LED filament map 1. The driver or controller 17 may or may not be the same unit as the control unit 6 described above. In other words, the controller 17 and the control unit 6 may be integrated into one and the same controller or control unit, or they may be mutually separate units. The controller 17 is configured to power the first, second and third plurality of LEDs 31, 41, 51 via the electrical circuitry 11 of the LED filament lamp 1. The controller 17 may further be configured for controlling at least one of the CCT of the LED filament lamp light and the CRI of the LED filament lamp light. The controller 17 may also be configured for controlling other parameters related to the LED filament lamp light sources and the LED filament lamp light.

The light bulb 12 further comprises an envelope 13 at least partially enveloping the at least one LED filament arrangement 1. The light bulb 12 further comprises a cap 14. As shown in FIG. 7, the controller 17 is arranged within the envelope 13. When comprising a cap 14, the controller 17 may also be arranged inside the cap 14 such that it is hidden from view. The light bulb 12 further comprises threading 15 for connection to a socket and a terminal 16 for connection to a source of electrical energy.

The envelope 13 of the light bulb 12 may further and optionally be provided with a coating 18, such as a reflective coating, covering at least a part of the envelope 13.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality.

1. A light emitting diode, LED, filament arrangement configured to, in operation, emit LED filament arrangement light, comprising:
at least one first LED filament configured to, in operation, emit first LED filament light having a first correlated color temperature, CCT1, at least one second LED filament configured to, in operation, emit second LED filament light having a second correlated color temperature, CCT2, wherein CCT2>CCT1, and at least one third LED filament configured to, in operation, emit third LED filament light having a third color temperature, CCT3, wherein CCT3>CCT2;
wherein each of the at least one first LED filament, the at least one second LED filament and the at least one third LED filament comprises a carrier of elongated shape, wherein a respective plurality of light emitting diodes of the at least one first LED filament, the at least one second LED filament and the at least one third LED filament in arranged on the respective carrier;
wherein the LED filament arrangement further comprises a control unit configured to control a first luminous flux, L1, of the first LED filament light emitted from the at least one first LED filament, to control a second luminous flux, L2, of the second LED filament light emitted from the at least one second LED filament and to control a third luminous flux, L3, of the third LED filament light emitted from the at least one third LED filament according to at least one predetermined setting in order to control a total correlated color temperature, CCTtot, of the LED filament arrangement light as a function of the at least one predetermined setting;
wherein the control unit is configured to control a switching of the at least one second LED filament as a function of the first luminous flux, L1, of the first LED filament light emitted from the at least one first LED filament; and
wherein the control unit is configured to control a switching of the at least one third LED filament as a function of the luminous flux, L2, of the second light emitted from the at least one second filament; and wherein:
$$450 K \geq ( CCT 2 - CCT 1 ) \geq 150 K ,$$
$$( CCT 3 - CCT 2 ) \geq 1000 K ,$$
$$CCT 3 \geq 3000 K , and$$
$$1500 K \leq CCT 1 \leq 2500 K ,$$
wherein the control unit is configured to increase the first luminous flux, L1, to a first predetermined threshold, and, subsequently at said first predetermined threshold, switching on the at least one second LED filament and increasing the second luminous flux, L2, to a second predetermined threshold, and, subsequently at said second predetermined threshold, switching on the at least one third LED filament and increasing the third luminous flux, L3, or
wherein the control unit is configured to increase the first luminous flux, L1, and the second luminous flux, L2, simultaneously;
wherein the increase in luminous flux of the second LED filament light is higher than the increase in luminous flux of the first LED filament light; and wherein the control unit is configured to increase the second luminous flux, L2, to a second predetermined threshold, and, subsequently at said second predetermined threshold, switching on the at least one third LED filament #6 and increasing the third luminous flux, L3.

2. A LED filament arrangement according to claim 1, wherein one of the following applies:
(i) the control unit is configured to increase the third luminous flux of the third LED filament light to a third predetermined threshold, and, subsequently at said third predetermined threshold, to decrease the first luminous flux, L1, of the first LED filament light or to switch off the at least one first LED filament;
(ii) the control unit is configured to increase the third luminous flux, L3, and simultaneously decrease the first luminous flux, L1, of the first LED filament light or switch off the at least one first LED filament-) at said second predetermined threshold.

3. A LED filament arrangement according to claim 1, wherein 400 K≥(CCT2−CCT1)≥200 K.

4. A LED filament arrangement according to claim 1, wherein at least for one value of in a range of 50-80% of a maximum luminous flux, Lmax, of the LED filament arrangement light CCTtot=3000 K.

5. A LED filament arrangement according to claim 1, wherein a maximum total correlated color temperature, CCTmax, of the LED filament arrangement light is at least 3500 K, preferably at least 4000 K.

6. A LED filament arrangement according to claim 1, wherein a minimum total correlated color temperature, CCTmin, of the LED filament arrangement light is at most 2300K.

7. A LED filament arrangement according to claim 1, wherein a maximum luminous flux, Lmax, of the LED filament arrangement light is at least 1000 lm, preferably at least 1300 lm.

8. A LED filament arrangement according to claim 1, and further comprising M first LED filaments, N second LED filaments and O third LED filaments, wherein 12≥M+N+O≥4, and wherein one of (i) N>M and O≥N, (ii) N≥M and O>N, (iii) N>M and O>N is fulfilled.

9. A LED filament arrangement according to claim 1, wherein CCT3≤6500K.

10. A LED filament arrangement according to claim 1, wherein CCTtot increases with increasing luminous flux of the LED filament arrangement light, and the increase in CCTtot is non-linear with respect to an increase of the luminous flux of the LED filament arrangement light.

11. A LED filament arrangement according to claim 10, wherein the higher the luminous flux of the LED filament arrangement light, the steeper the increase in CCTtot.

12. A LED filament lamp comprising the LED filament arrangement according to claim 1, and further comprising a light transmissive envelope and a base for electrically and mechanically connecting the LED filament lamp to a socket or a socket of a luminaire.

13. A luminaire comprising a LED filament lamp according to claim 12 or comprising the LED filament arrangement.
